(19) United States
(12) Patent Application Publication
(10) Pub. No.: US 2026/0004134 A1
(43) Pub. Date: Jan. 1, 2026

(54) MULTI-HEAD MACHINE LEARNING MODEL FOR LEAD AND QUALIFIED LEAD PREDICTION

(71) Applicant: Microsoft Technology Licensing, LLC, Redmond, WA (US)

(72) Inventors: Lijun PENG, Sunnyvale, CA (US); Yingxia Shi, Sunnyvale, CA (US); Ruoying Wang, Sunnyvale, CA (US); Yi Zhang, Sunnyvale, CA (US); Shawn F. Ren, Sunnyvale, CA (US); Mindaou Gu, Saratoga, CA (US); David Merrill Pardoe, Mountain View, CA (US)

(21) Appl. No.: 18/759,429

(22) Filed: Jun. 28, 2024

(51) Int. Cl. G06N 3/084

(52) U.S. Cl. CPC G06N 3/084

(57) ABSTRACT

In an example embodiment, a delayed qualified lead machine learning model is trained to predict, for any particular piece of interaction data, a likely delay between the interaction time and a time at which an indication of a qualified lead is provided (if one is to be provided). Thus, for example, the delayed qualified lead machine learning model may predict that, given a particular user's interaction with a particular piece of content, the user is likely to be labeled as a qualified lead within 40 days if the user will become a qualified lead at all. This prediction can then be used to exclude the interaction data from the training data for a separate machine learning model without excluding other pieces of interaction data whose predicted delays might have been shorter, helping alleviate the data scarcity issue.

### TECHNICAL FIELD

The present disclosure generally relates to technical problems encountered in machine learning. More specifically, the present disclosure relates to a multi-head machine learning model for both lead and qualified lead prediction.

### BACKGROUND

The rise of the Internet has occasioned two disparate yet related phenomena: the increase in the presence of online networks, such as social networking services, with their corresponding user profiles visible to large numbers of people, and the increase in the use of these online networking services to provide content. An example of such content is advertising content, but similar issues can arise with many different types of content. In the advertising content example, advertisements (also known as sponsored content) may be posted to a social networking service to be presented to users of the social network service, oftentimes in conjunction with non-advertisement content (also known as organic content). For example, advertisements may be interspersed in a social networking feed on the social networking service, with a feed being a series of various pieces of content presented in reverse chronological order, along with non-advertisement content such as a combination of notifications, articles, and job listings.

### BRIEF DESCRIPTION OF THE DRAWINGS

Some embodiments of the technology are illustrated, by way of example and not limitation, in the figures of the accompanying drawings.

FIG. 1 is a block diagram showing the functional components of a social networking service, including a data processing module referred to herein as a search engine, for use in generating and providing search results for a search query, consistent with some embodiments of the present disclosure.

FIG. 2 is a block diagram illustrating the application server module of FIG. 1 in more detail, in accordance with an example embodiment.

FIG. 3 is a block diagram illustrating a successful content model in more detail, in accordance with an example embodiment.

FIG. 4 is a block diagram illustrating a fixed effect model in accordance with an example embodiment.

FIG. 5 is a flowchart of an example method, in accordance with an example embodiment.

FIG. 6 is a block diagram illustrating a software architecture, in accordance with an example embodiment.

FIG. 7 illustrates a diagrammatic representation of a machine in the form of a computer system within which a set of instructions may be executed for causing the machine to perform any one or more of the methodologies discussed herein, according to an example embodiment.

### DETAILED DESCRIPTION

### Overview

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

When posting content in an online network it is typically desirable to attempt to maximize the likelihood that the viewer will perform some action that is beneficial to the entity that performed the posting. Sometimes these benefits are instantaneous, such as the viewer clicking on and engaging in the content, but sometimes these benefits are delayed, such as a conversion. A conversion is an event where the viewer has performed an additional desired action, typically a final desired action, after having viewed the content. Oftentimes this conversion is a “sale”, where the user agrees to purchase or otherwise provide renumeration in exchange for some good or service.

It may be desirable to use a machine learning model to aid in determining whether to post content to a particular viewer. This machine learning model may be trained to predict, for example, a likelihood of the viewer performing a conversion, or a combination of that likelihood with a value of such a conversion. The prediction may be used in a variety of ways, such as by strictly determining whether or not to display a piece of content to a particular user, or as an aid in determining a price that the entity performing the posting should pay to have the piece of content to the particular user (e.g., a bid amount for the impression).

Technical problems are encountered, however, in the use of machine learning models for such purposes. One such technical problem is encountered because the training data used to train such machine learning models may be based on conversions and where such training data is sparse.

In the case of business-to-consumer (“B2C”) environments, the conversion, while oftentimes slightly delayed from the actual engagement with the piece of content itself (e.g., clicking on the content), typically still occurs within a short period of time of the engagement (e.g., a few hours or days, possibly as long as a few weeks). The same, however, is not true of business-to-business (“B2B”) environments, where the conversion may be longer than B2C environments and can take months.

Since the training data is already sparse, increasing reliability of the predictions requires use of as much training data as is possible, including using historical conversion data as a predictor for future conversions. Since, however, the conversion data for many B2B environments is delayed, this means that the training either must take place without the conversion data, making the machine learning model less reliable due to sparsity, or the training must take place after some long preset period (e.g., 6 month), making the training data less fresh, which can also impact reliability of the predictions.

Furthermore, in certain scenarios there may be multiple different types of delayed labels. For example, in certain industries, there is a concept of a “lead”. A lead is a consumer who has the potential of turning into a customer (e.g., potential conversion). In some industries, however, there may further be breakdown of different types of leads. For example, there may be a traditional lead, which could be defined for a particular industry as being any viewer who has interacted with an entity that is considering posting a piece of content, but there can also be a qualified lead, which is a viewer that has gone through some qualifying criteria to assess their quality, fit, and readiness to buy, such as by registering directly with the company for an event or additional information. In some industries, qualified leads can even be broken down into additional categories, such as a Sales Qualified Lead (SQL) and Marketing Qualified Lead (MQL).

Information about who is or isn't a lead can be gathered by an online network in which the entity posts content, whereas information about who is or isn't a qualified lead can be gathered by the entity itself. Thus, data about who is or isn't a lead can come from one data source and data about who is or isn't a qualified lead can come from a completely different data source. Yet both of these data might prove useful in predicting whether a particular user will be a lead and also both of these data might prove useful in predicting whether a particular user will be a qualified lead. Furthermore, the prediction about whether a particular user is a lead or a qualified lead can itself be useful in downstream predictions, such as a prediction of the likelihood that the user's interaction will result in a conversion.

Due to the aforementioned potential delays in the labeling of interaction data with the label “lead” or “qualified lead” (or similar labels), a technical issue is encountered in that there can be false negatives in the data, which may be used as training data for a prediction model. For example, a user may click on a piece of content on January 1^{st} and then later become a qualified lead on January 20^{th}. If the interaction data is used as training data between January 1^{st} and January 20^{th}, it will appear as if it was a negative label (i.e., the machine learning algorithm will assume that the user did not become a qualified lead), but this will be a false negative (because the user eventually did become a qualified lead). But differentiating this false negative from a true negative (e.g., the user has not become a qualified lead up to this point and will not become a qualified lead) is challenging.

In an example embodiment, a delayed qualified lead machine learning model is trained to predict, for any particular piece of interaction data, a likely delay between the interaction time and a time at which an indication of a qualified lead is provided (if one is to be provided). Thus, for example, the delayed qualified lead machine learning model may predict that, given a particular user's interaction with a particular piece of content, the user is likely to be labeled as a qualified lead within 40 days if the user will become a qualified lead at all. This prediction can then be used to exclude the interaction data from the training data for a separate machine learning model without excluding other pieces of interaction data whose predicted delays might have been shorter, helping alleviate the data scarcity issue.

Additionally, in an example embodiment, this separate machine learning model is a multi-head machine learning model including a first head that is trained to predict a first likelihood that an input interaction will cause a lead and a second head that is trained to predict a second likelihood that the input interaction will cause a qualified lead. This also helps alleviate the scarcity problem because in many scenarios finding labeled data indicating whether users became qualified leads can be difficult. Training a single model to predict a likelihood that a user can therefore result in inaccurate predictions due to the scarcity of such training data. Since there is overlap in the cases where a user becomes a lead and a user becomes a qualified lead, using a single model to predict the likelihood of both, using combined training data regarding users who became leads and users who became qualified leads, increases the accuracies of predictions of the likelihoods over what the accuracies would be if separate models were utilized. This may be termed “transfer learning” because the part of the model that learns to predict qualified leads also learns from the part of the model that learns to predict leads, and vice versa.

In a further example embodiment, the training data that is used to perform the training of the multi-head machine learning model excludes training data uploaded by an entity that has not uploaded a piece of interaction data having a label indicating whether a corresponding user is qualified lead within a preset threshold amount of time. This may be known as a qualified lead upload check. This helps alleviate another false negative problem, namely one that occurs because entities often do not track or otherwise do not upload qualified lead labels. If this upload check was not performed, therefore, then the model training would presume a lot of a negative qualified lead labels on data from entities that are simply not actively uploading qualified lead labels as opposed to data where the lack of a qualified lead label actually has meaning.

### DESCRIPTION

In an example embodiment, novel techniques are presented to solve various technical problems when utilizing machine learning models.

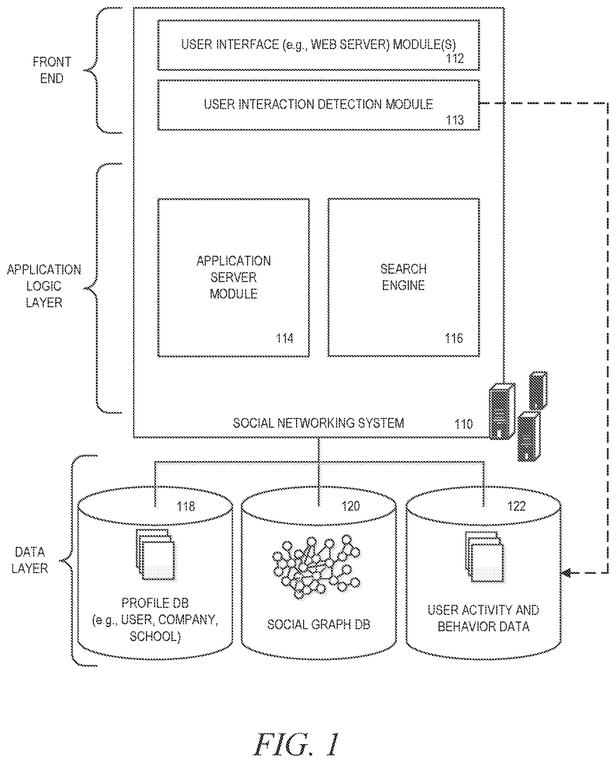

FIG. 1 is a block diagram showing the functional components of a social networking service, including a data processing module referred to herein as a search engine, for use in generating and providing search results for a search query, consistent with some embodiments of the present disclosure.

As shown in FIG. 1, a front end may comprise a user interface module 112, which receives requests from various client computing devices and communicates appropriate responses to the requesting client devices. For example, the user interface module(s) 112 may receive requests in the form of Hypertext Transfer Protocol (HTTP) requests or other web-based Application Program Interface (API) requests. In addition, a user interaction detection module 113 may be provided to detect various interactions that users have with different applications, services, and content presented. As shown in FIG. 1, upon detecting a particular interaction, the user interaction detection module 113 logs the interaction, including the type of interaction and any metadata relating to the interaction, in a user activity and behavior database 122.

An application logic layer may include one or more various application server modules 114, which, in conjunction with the user interface module(s) 112, generate various user interfaces (e.g., web pages) with data retrieved from various data sources in a data layer. In some embodiments, individual application server modules 114 are used to implement the functionality associated with various applications and/or services provided by the social networking service.

As shown in FIG. 1, the data layer may include several databases, such as a profile database 118 for storing profile data, including both user profile data and profile data for various organizations (e.g., companies, schools, etc.). Consistent with some embodiments, when a person initially registers to become a user of the social networking service, the person will be prompted to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 118. Similarly, when a representative of an organization initially registers the organization with the social networking service, the representative may be prompted to provide certain information about the organization. This information may be stored, for example, in the profile database 118 or another database (not shown). In some embodiments, the profile data may be processed (e.g., in the background or offline) to generate various derived profile data. For example, if a user has provided information about various job titles that the user has held with the same organization or different organizations, and for how long, this information can be used to infer or derive a user profile attribute indicating the user's overall seniority level or seniority level within a particular organization. In some embodiments, importing or otherwise accessing data from one or more externally hosted data sources may enrich profile data for both users and organizations. For instance, with organizations in particular, financial data may be imported from one or more external data sources and made part of an organization's profile. This importation of organization data and enrichment of the data will be described in more detail later in this document.

Once registered, a user may invite other users, or be invited by other users, to connect via the social networking service. A “connection” may constitute a bilateral agreement by the users, such that both users acknowledge the establishment of the connection. Similarly, in some embodiments, a user may elect to “follow” another user. In contrast to establishing a connection, the concept of “following” another user typically is a unilateral operation and, at least in some embodiments, does not require acknowledgement or approval by the user that is being followed. When one user follows another, the user who is following may receive status updates (e.g., in an activity or content stream) or other messages published by the user being followed, relating to various activities undertaken by the user being followed. Similarly, when a user follows an organization, the user becomes eligible to receive messages or status updates published on behalf of the organization. For instance, messages or status updates published on behalf of an organization that a user is following will appear in the user's personalized data feed, commonly referred to as an activity stream or content stream. In any case, the various associations and relationships that the users establish with other users, or with other entities and objects, are stored and maintained within a social graph in a social graph database 120.

As users interact with the various applications, services, and content made available via the social networking service, the users' interactions and behavior (e.g., content viewed, links or buttons selected, messages responded to, etc.) may be tracked, and information concerning the users' activities and behaviors may be logged or stored, for example, as indicated in FIG. 1, by the user activity and behavior database 122. This logged activity information may then be used by a search engine 116 to determine search results for a search query.

Although not shown, in some embodiments, a social networking system 110 provides an API module via which applications and services can access various data and services provided or maintained by the social networking service. For example, using an API, an application may be able to request and/or receive one or more recommendations. Such applications may be browser-based applications or may be operating system-specific. In particular, some applications may reside and execute (at least partially) on one or more mobile devices (e.g., phone or tablet computing devices) with a mobile operating system. Furthermore, while in many cases the applications or services that leverage the API may be applications and services that are developed and maintained by the entity operating the social networking service, nothing other than data privacy concerns prevents the API from being provided to the public or to certain third parties under special arrangements, thereby making the navigation recommendations available to third-party applications and services.

Although the search engine 116 is referred to herein as being used in the context of a social networking service, it is contemplated that it may also be employed in the context of any website or online services. Additionally, although features of the present disclosure are referred to herein as being used or presented in the context of a web page, it is contemplated that any user interface view (e.g., a user interface on a mobile device or on desktop software) is within the scope of the present disclosure.

In an example embodiment, when user profiles are indexed, forward search indexes are created and stored. The search engine 116 facilitates the indexing and searching for content within the social networking service, such as the indexing and searching for data or information contained in the data layer, such as profile data (stored, e.g., in the profile database 118), social graph data (stored, e.g., in the social graph database 120), and user activity and behavior data (stored, e.g., in the user activity and behavior database 122). The search engine 116 may collect, parse, and/or store data in an index or other similar structure to facilitate the identification and retrieval of information in response to received queries for information. This may include, but is not limited to, forward search indexes, inverted indexes, N-gram indexes, and so on.

At a threshold level, the present solution provides for the connecting of isolated optimization components and the continued automation of each component through artificial intelligence technologies.

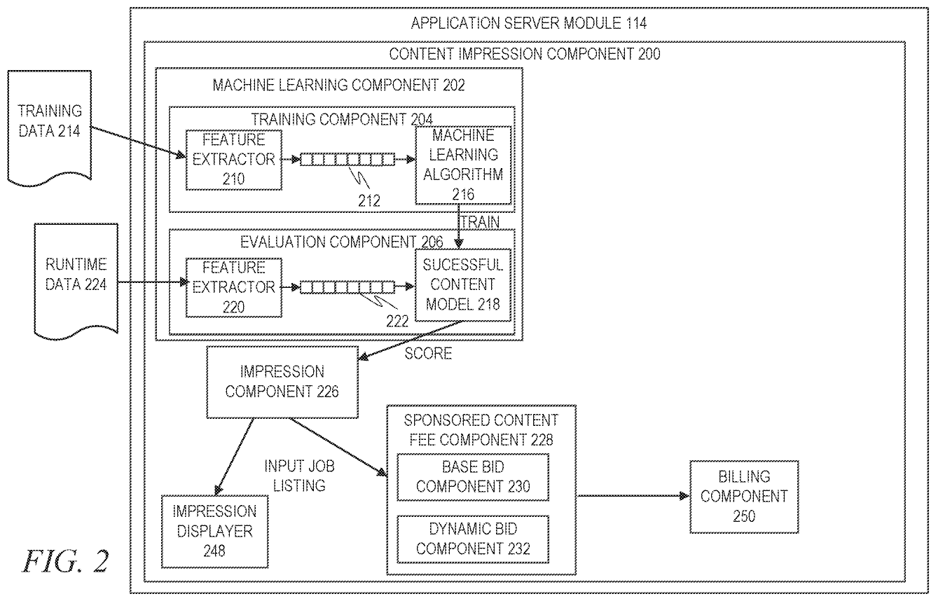

FIG. 2 is a block diagram illustrating application server module 114 of FIG. 1 in more detail, in accordance with an example embodiment. While in many embodiments the application server module 114 will contain many subcomponents used to perform various different actions within a social networking system, in FIG. 2 only those components that are relevant to the present disclosure are depicted.

A content impression component 200 may receive, at runtime, one or more pieces of content and determine which users of the online network to present the pieces of content to as “impressions”. An impression is a single display of the job listing in a graphical user interface. There may be numerous ways these impressions may be presented and numerous channels on which these impressions may be presented. For example, the impressions may be presented in an email to a user, in a feed of the online network, or as results of a search. Some of these impressions may be for pieces of content where the corresponding entity that posted the piece of content has agreed to pay for the impression. Such impressions are called “sponsored impressions”. It should be noted that there is a distinction between the corresponding entity having agreed to pay for the impression and the corresponding entity actually paying for the impression. It is possible that the entity may have agreed to pay for an impression but, at the time the impression is made, a daily budget established by the entity has been used up, and thus it becomes possible for the sponsored impression to be displayed without an actual charge being applied to the entity's account.

More particularly, companies may establish a daily budget they want to spend and a cost per impression based on a predicted number of impressions that they believe will occur each day. The actual display of the pieces of content, however, are based on a variety of factors that may vary based on the individual sets of users potentially served the job listing on a particular day.

In an example embodiment, a machine learning models is utilized to establish and refine the price set for each impression of a piece of sponsored content in the online network

It should be noted that organic content may be ranked separately using its own, independent ranking model, or the function(s) related to ranking the organic content may be integrated into the machine learned model used for the sponsored pieces of content described below. The organic ranking functions are beyond the scope of the present disclosure.

The machine learned model is used to estimate the likelihood that display of a piece of sponsored content is “successful.” Success may be defined differently for different types of sponsored content, and will be described in more detail below, but in an example embodiment success will be measured by whether or not the display of the sponsored content resulted in a conversion. The score is then used to determine whether to display a particular sponsored piece of content to a particular user. If a piece of content is sponsored, display of the piece of content causes a charge to be assigned to the impression and the charge deducted from an entity's daily budget. The price charged for the sponsored piece of content is based on a bid that is calculated by first establishing a base bid for the sponsored piece of content. This base bid is based on an estimate of the number of views of the pieces of content. The base bid is then dynamically modified at impression-time to establish the actual price charged for a particular impression of the sponsored piece of content.

The content impression component 200 may include a machine learning component 202. The machine learning component 202 may include a training component 204 and an evaluation component 206. The training component 204 uses feature extractor 210 to extract one or more features 212 from training data 214. The training data 214 may include, for example, user profiles, corresponding user activity information (e.g., interactions the users made with the online network), and historical job listing information. The one or more features 212 may then be fed to a machine learning algorithm 216 that trains a successful content model 218. The successful content model 218 may be specifically trained to output a score for an input user based on a likelihood that, if the input user is presented with the content, then that sponsored piece of content will be “successful”. Success in this context may be defined in a number of different ways based on the objectives of the designer of the successful content model 218. While it is possible, for example, for success to measured in terms of whether or not the user selected (e.g., “clicked on”) or otherwise engaged with the piece of content itself, in an example embodiment success is measured in terms of whether or not a conversion was made. In an example embodiment, the machine learning algorithm 216 may be selected from among many different potential supervised or unsupervised machine learning algorithms. Examples of supervised learning algorithms include artificial neural networks, Bayesian networks, instance-based learning, support vector machines, random forests, linear classifiers, quadratic classifiers, k-nearest neighbor, decision trees, and hidden Markov models. Examples of unsupervised learning algorithms include expectation-maximization algorithms, vector quantization, and information bottleneck method

At runtime, feature extractor 220 may extract one or more features 222 from runtime data 224. The runtime data 224 may include the input user's profile, activity information, and information about a particular sponsored piece of content being considered. The one or more features 222, which then correspond just to the input user and the particular sponsored piece of content being considered, are passed to the successful content model 218, which outputs a score for the combination of the input user and the particular sponsored piece of content being considered. This score is then passed to an impression component 226. The impression component 226 then determines whether or not to display the sponsored piece of content being considered to the user based on this score. In an example embodiment, this is performed by comparing the score to the score of other sponsored pieces of content being considered. In the case where the pieces of content are sponsored, there may be a certain number of designated “slots” for display of sponsored pieces of content among organic pieces of content. For example, there may be three slots for sponsored pieces of content for every seventeen slots for organic pieces of content. In an example embodiment, only those sponsored pieces of content whose scores are in the top number of scores of sponsored pieces of content will be displayed. Thus, in the above example, if the sponsored piece of content being considered has a score within the top three scores of the sponsored pieces of content being considered for the input user, then it will be displayed. In other example embodiments, the scores are compared to a predetermined threshold and only if that threshold is transgressed are the corresponding sponsored pieces of content displayed.

A sponsored content fee component 228 includes a base bid component 230 and a dynamic bid component 232. The base bid component 230 establishes a base bid for the sponsored piece of content being considered. As described earlier, this base bid was typically determined using the prior day's empirical number of impressions of the sponsored piece of content being considered and a daily budget for the sponsored piece of content.

At runtime, and particularly when the online network is determining whether or not to display an impression of the sponsored piece of content being considered to the input user, the dynamic bid component 232 dynamically adjusts the base bid to an actual bid that is then charged to the entity who posted sponsored piece of content being considered.

In the case of sponsored pieces of content, by dynamically setting and adjusting prices of sponsored pieces of content based on objectives related to the sponsored job listing's budget utilization, performance, and/or popularity, utilization of the job listing's budget is increased, the value of the pieces of content to the entities posting the sponsored pieces of content and to applicants is increased, and the delivery of the sponsored pieces of content is performed in a manner that reflects recent feedback and/or activity related to the content.

Impression displayer 248 then causes the input sponsored job listing to be displayed for a particular user while billing component 250 causes the entity posting the input sponsored job listing to be billed for the impression at the rate set by the dynamic bid component 232.

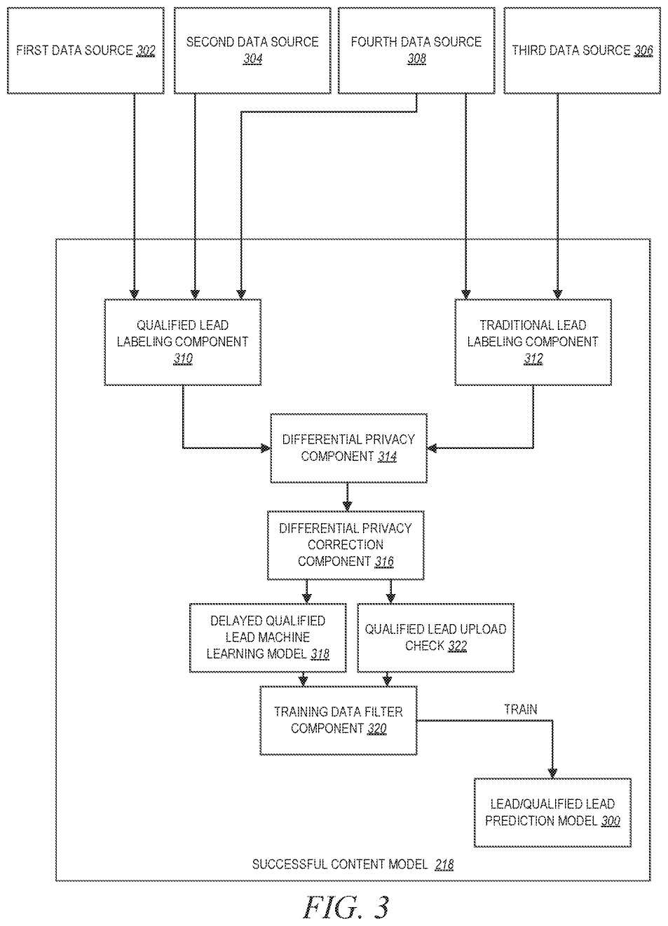

FIG. 3 is a block diagram illustrating a successful content model 218 in more detail, in accordance with an example embodiment. Here, the successful content model 218 follows a pipeline approach. The pipeline approach recognizes that lifecyle of interaction between a user and an entity posting a piece of content oftentimes can evolve over several different types of interactions. What makes a B2B environment more challenging to track conversions is that there are many entities involved in making decisions, interacting with content, etc., which leads to extended interaction times, whereas B2C typically involves a single consumer interacting with an entity.

While some users, typically in a B2C environment, may progress from initial interaction (e.g., click) on a piece of content to a conversion fairly quickly and directly, other users, and especially users in a B2B environment, take many more types of interactions before progressing to a conversion. For example, a user in a B2B environment may begin with a click on a piece of content sponsored by an entity then progress to a lead by pressing a button on the piece of content and submitting contact information, and then progress to a qualified lead by interacting in some way with the entity directly (e.g., submitting a questionnaire of the entity's website), and then finally later to a conversion. In a pipeline approach, therefore, rather than just merely modeling a likelihood that a user will progress from a click to a conversion, the modeling actually involves taking each stage in the pipeline and modeling that stage, such as modeling the likelihood that a user's click will result in them becoming a lead, the likelihood that the user becoming a lead will result in them becoming a qualified lead, and then the likelihood that the user becoming a qualified lead will result in a conversion.

In an example embodiment, however, rather than creating different machine learning models for all of these stages in the pipeline, a single model is used having multiple “heads” that each allow for the modeling of an individual stage, but overall acts to predict the outcome of one of the stage. Thus, in an example embodiment, a lead/qualified lead prediction model 300 is a machine learning model trained to predict both a likelihood that a user will become a lead and a likelihood that the user will become a qualified lead. In an example embodiment, the lead/qualified lead prediction model 300 is a multi-head machine learning model that is optimized to predict both whether a user will wind up becoming a lead and whether the user will wind up becoming a qualified lead.

The multi-head machine learning model is designed for multi-task learning, where it learns related tasks in parallel leveraging of a shared representation. The learnings of each task help with better learning of other tasks and thus improves generalizations. In an example embodiment, the multi-task machine learning model is a Generalized Deep Mixed (GDMix) model. A GDMix model comprises a combination of multiple models, one of which is a global model (also known as a fixed effect model) and the remainder are personalized random effects models. The global model is trained on the entirety of a set of training data, while the various random effects model are trained only on particular slices of the set of training data, depending upon what they are being personalized for.

In an example embodiment, the fixed effect model is a TensorFlow classification model having two heads, one head that predicts a likelihood that a user will become a lead based on a click and the other head that predicts a likelihood that the user will become a qualified lead based on a click. The fixed effect model may be a neural network.

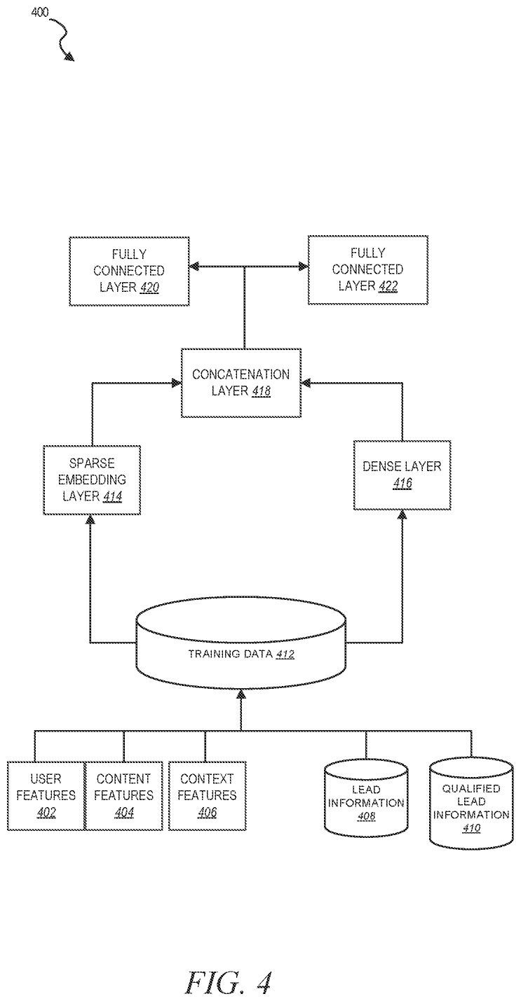

FIG. 4 is a block diagram illustrating a fixed effect model 400 in accordance with an example embodiment. Here, various user features 402, content features 404, and context features 406 are joined with lead information 408 and qualified lead information 410 to produce training data 412. The training data 412 is fed to both a sparse embedding layer 414 and a dense layer 416. The output from both the sparse embedding layer 414 and the dense layer 416 is fed to a concatenation layer 418, whose output is then fed to each of the heads, namely a fully connected layer 420 that predicts likelihood of a user becoming a lead and a fully connected layer 422 that predicts likelihood of the user becoming a qualified lead.

The two heads can be combined as:

$$( 1 - {I}_{QL} ) \cdot pLTR + {I}_{QL} \cdot pQL$$

Where I_{QL}=1 if one wants to predict for a qualified lead based on an optimization target specified by an entity and I_{QL}=0 otherwise.

The two heads each have a binary classification loss, using the traditional lead label and qualified lead labels, respectively, and total loss is calculated as

$$loss = λ {loss}_{LTR} + ( 1 - λ ) ( {I}_{OPTIMIZE\_QL} {loss}_{QL} + ( 1 - {I}_{OPTIMIZE\_QL} ) {loss}_{LTR} )$$

where I_{OPTIMIZE_QL}=1 if one wants to optimize on the QL label for this row and =0 otherwise

Referring back to FIG. 3, the random effect model may be logistic regression model. Additionally, because conversion data is so sparse, it is valuable to utilize such conversion data from as many different data sources as possible. For example, one data source may be attributed (joined with click data of individual viewers, and thus attributable to individual viewers) and another data source may be unattributed (not attributable to individual viewers, such as conversion data from campaigns as a whole without individual viewer-level results). Privacy, however, becomes a concern with attributed data, as viewers may be uneasy with having their personal interaction information being found out by third parties. To address these privacy concerns, one solution would be to use differential privacy. Differential privacy involves adding noise to the data in a manner that obscures values at an induvial level without affecting reliability of predictions made using the data.

A further technical issue arises, however, with applying differential privacy to data from multiple sources. Specifically, especially with online interaction data, it is possible for there to be overlap in the data. A particular viewer's interaction data may be captured both by the data source that has the particular viewer's individual interaction data but also be captured by the data source that only captures campaign-level interaction data. The result, however, is that not only is it possible for the viewer's data to essentially be used twice, due to the differential privacy techniques applied to the data it is possible that the resultant data from the two data sources may be conflicting with each other. For example, if viewer A produced a conversion, a value of “1” may be attributed to each piece of data, whether attributed or not, that reflects viewer A's interaction data, whereas a value of “0” may be attributed if viewer A did not produce a conversion. A differential privacy technique may cause these values to be occasionally flipped to hide individual-level data, without impacting the overall effectiveness of the machine learning model that is trained on this information. The multiple sources of information, however, could result in a scenario where viewer A's interaction data in one source's data has been flipped from 1 to 0 whereas viewer A's interaction data in another source's data has not been flipped and thus remains at 1. This creates a conflict where the same information (viewer A's interaction data) has been labeled as being both a conversion and not a conversion.

Another technical issue that arises is that in addition to data sources potentially duplicative, there can also be additional data sources that can be useful in making a prediction, even predictions that go beyond what the data is intended to convey.

In an example embodiment, a correction technique is performed on multiple types of data to counteract any discrepancies introduced by differential privacy processes performed on at least some of the data. This allows sensitive data derived from multiple different sources to be used as training data for a machine learning model without negatively impacting reliability of predictions produced by the machine learning model.

Thus, with reference to FIG. 3, a first data source 302 provides information about unattributed qualified leads, a second data source 304 provides information about attributed qualified leads, and a third data source 306 information about traditional leads.

Interaction data is obtained from a fourth data source 308 and represents the training data itself. This interaction data may include any interactions performed by users on content, such as selecting (e.g., clicking on) the content, sharing or liking the content, or converting. This interaction data, however, lacks labels about whether or not the user is a traditional lead and/or qualified lead. Thus, a qualified lead labeling component 310 acts to label the training data with an indication of whether the corresponding users were qualified leads and a traditional lead labeling component 312 acts to label the training data with an indication of whether the corresponding users were leads.

A differential privacy component 314 is used to provide privacy to the attributed training data (such as the data that was labeled with labels from the second data source 304 or the third data source 306), so that a third-party is not able to learn or deduce that any particular user has or has not performed any particular interaction. In an example embodiment, the differential privacy component 314 specifically is used to obfuscate whether or not a conversion occurred based on a user's interaction data. The information about whether or not a conversion occurred may be stored as either a 1 (conversion occurred) or a 0 (no conversion occurred). The differential privacy component 314 applies the following algorithm to occasionally flip this value (0→1 or 1→0) based on a probability that will ensure that any effect of such flipping will not significantly affect the predictions made by the successful content model 218. In an example embedment, this algorithm is as follows:

$$\begin{matrix}M ( b ) = b with probability \frac{{e}^{ϵ}}{1 + {e}^{ϵ}} \\ M ( b ) = 1 - b otherwise\end{matrix}$$

In an example embodiment, epsilon is set at 4.

As mentioned above, however, an issue arises with using the differential privacy component 314 on the qualified lead data because it is possible to have duplicates of any particular piece of training data, and the differential privacy component 314 could therefore cause inconsistent values in these duplicates. This adds even more noise to the training data, possibly so much noise that the successful content model 218 does not make its predictions accurately.

As such, in an example embodiment, a differential privacy correction component 316 acts to correct effects introduced by the differential privacy component 314 to reduce this additional noise back to an acceptable level. More particularly, in an example embodiment, the differential privacy correction component 316 acts to identify duplicate pieces of training data and generate a single label to be applied. In some example embodiments, one of the duplicate pieces of training data is then deleted and the generated single label is applied to the remaining piece of training data of the duplicates. In an example embodiment, the differential privacy correction component 316 performs its correction by comparing the values for the duplicative pieces of training data and generates a final label based on the following:

| DP-applied | No DP Applied | |
|---|---|---|
| data value | data value | Final label |
| 0 | 0 | 0 |
| 0 | 1 | 1 |
| 1 | 0 | 0 with probability 1 - Sigmoid(ε) |
| | | 1 with probability Sigmoid(ε) |
| 1 | 1 | 0 with probability 1 - Sigmoid(ε) |
| | | 1 with probability Sigmoid(ε) |

Where ε is a constant.

Referring back to FIG. 3, it should be noted that while the first data source 302 and the second data source 304 are depicted as separate data sources, they may actually be derived from a single data source For example, both may be desired from data provided by an entity considering posting a piece of content (such as a company), such as a list of qualified leads provided by that entity, but the data from the second data source may be attributed by attributing it by comparing it to information about known users from an online network.

As mentioned earlier, in the training data the labels of whether a user has converted may not be accurate based upon whether enough of a delay in time has elapsed since the user first clicked. In B2B environments especially, it is not uncommon for there to be up to a six month delay between a click and a conversion, and as such the training data may not be accurate if it is obtained prior to the delay elapsing. The problem is that this delay may vary based on the context and the user. One solution is just to use a single universal delay that captures most users' delay periods (say, a 6 month delay). Such a solution, however, suffers technical drawbacks because then the training data being used is not fresh and does not capture recent trends.

As such, in an example embodiment, a specialized machine learning model is trained to estimate a maximum delay between an interaction time and a qualified lead label. The result is that a dynamic balance is struck between fresh data and accurate data. This specialized machine learning model is depicted here as the delayed qualified lead machine learning model 318. Its output is then used by a training data filter component 320 to filter out any data from the training data whose time from the time of the underlying interaction (the time of the interaction in the piece interaction data used as training data) is less than the predicted maximum delay.

In some example embodiments, the delayed qualified lead machine learning model 318 may be implemented as follows:

Each past event can be characterized by the outcome of the following 5 random variables:
X a set of features,
Y∈{0, 1} indicating whether a qualified lead label has already occurred;
C∈{0, 1} indicating whether the user will eventually become a qualified lead;
D the delay between the interaction and the user being labeled as a qualified lead (if at all)
E the elapsed time since the interaction.

The main relation between these variables is that if a qualified lead label has not been observed, it is either because the user will not become a qualified lead or because they will become a qualified lead later, in other words,

$$Y = 0 ⇔ C = 0 or E < D$$

This obviously implies that if the user has already become a qualified lead (Y=1) the value of C is observed:

Y=1⇒C=1 The only independence assumption required in the following derivation is that the pair (C, D) is independent of E given X,

$$P r ( C , D \vert X , E ) = Pr ( C , D \vert X )$$

This independence makes sense since E, the elapsed time since the interaction, has an influence only on Y, whether the user has already converted to a qualified lead or not.

Lower case letters denote observed values of these random variables: given a data set comprising of triplets (xᵢ, yᵢ, eᵢ) and in addition, if yᵢ=1, and given the delay dᵢ between the interaction and the conversion to qualified lead.

Two parametric models are used to fit this data: a probability of conversion Pr (C|X) and a model of the conversion delay Pr (D|X, C=1). Once these two models are trained, the former is used to predict the probabilities of conversion to qualified lead while the latter is discarded.

Both models are generalized linear models: the first one could be a standard logistic regression model,

$$Pr ( C = 1 \vert X = x ) = p ( x ) with p ( x ) = \frac{1}{1 + exp ( - {w}_{c} \cdot x )} ,$$

and the second one is an exponential distribution of the (nonnegative) delay,

$$Pr ( D = d \vert X = x , C - 1 ) = λ ( x ) exp ( - λ ( x ) d )$$

In some example embodiments, rather than logistic regression a neural network (such as a multi-head generalized deep mixed model that predicts Pr (C=1| X=x) where C is the qualified lead or traditional lead, and X are the features.)

The function λ(x) is called the hazard function in survival analysis and in order to ensure that λ(x)>0 we use the parametrization λ(x)=exp (w_{d}·x). The parameters of the model are thus the two weight vectors w_{c} and w_{d} is:

Under these models, the probability of a conversion to qualified lead event

$$Pr ( Y - 1 , D = {d}_{i} \vert X = {x}_{i} , E = {e}_{i} ) = Pr ( C = 1 , D = {d}_{i} \vert X = {x}_{i} , E = {e}_{i} ) = Pr ( C = 1 , D = {d}_{i} \vert X = {x}_{i} , E = {e}_{i} ) = Pr ( C = 1 , D = {d}_{i} \vert X = {x}_{i} ) = PR ( D = {d}_{i} \vert X = {x}_{i} , C = 1 ) Pr ( C = 1 \vert X = {x}_{i} )$$

The first equality comes from the fact eᵢ has to be larger than dᵢ, while the second equality results from the conditional independence.

By the law of total probabilities, and again using the conditional independence of C and E given X, the probability of not having observed a conversion to qualified lead can be written as:

$$P r ( Y = 0 \vert X = {x}_{i} , E = {e}_{i} ) = Pr ( Y = 0 \vert C = 0 , X = {x}_{i} , E = {e}_{i} ) P ( C = 0 \vert X = {x}_{i} )$$

Furthermore, the probability of delayed conversion to qualified lead is:

$$Pr ( Y = 0 \vert C - 1 , X = {x}_{i} , E = {e}_{i} ) = Pr ( D > E \vert C = 1 , X = {x}_{i} , E = {e}_{i} ) = {\int }_{{e}_{i}}^{∞} λ ( x ) exp ( - λ ( x ) t ) dt$$

The likelihood of not observing a conversion to qualified lead can finally be written as:

$$Pr ( Y = 0 \vert X = {x}_{i} , E = {e}_{i} ) = 1 - p ( {x}_{i} ) + p ( {x}_{i} ) exp ( - λ ( {x}_{i} ) {e}_{i} ) .$$

Optimization of the delayed qualified lead machine learning model may be performed in any of a number of different ways. In the first, an Expectation-Maximization (EM) algorithm my be used to untangle both of the models within the delayed qualified lead machine learning model by inferring the value of the hidden variable C. The second involves directly and jointly optimizing using gradient descent.

The EM algorithm may be implemented as follows.

In an expectation step, for a given data point (xᵢ, yᵢ, eᵢ), one needs to compute the posterior probability of the hidden variable,

$$Pr ( C = 1 \vert X = {x}_{i} , Y = {y}_{i} ) := {w}_{i}$$

$$If {y}_{i} = 1 , then {w}_{i} = 1. If {y}_{i} = 0 , then :$$

$$Pr ( C = 1 \vert Y = 0 , X = {x}_{i} , E = {e}_{i} ) = Pr ( Y = 0 \vert C = 1 , X = {x}_{i} , E = {e}_{i} ) Pr ( C = 1 \vert X = {x}_{i} )$$

In a maximization step, the quantity to be maximized during the M step is an expected log-likelihood according to the distribution computed during the E step:

$${\sum }_{y , {y}_{i} = 1} log Pr ( Y = 1 , D = {d}_{i} \vert X = {x}_{i} , E = {e}_{i} ) + {\sum }_{i , {y}_{i} = 0} ( 1 - {w}_{i} ) log Pr ( Y = 0 , C = 0 \vert X = {x}_{i} , E = {e}_{i} ) + {w}_{i} log Pr ( Y = 0 , C = 1 \vert X = {x}_{i} , E = {e}_{i} )$$

The expected log likelihood of a unlabeled sample turns out to be:

$$( 1 - {w}_{i} ) log Pr ( Y = 0 , C = 0 \vert X = {x}_{i} , E = {e}_{i} ) = ( 1 - {w}_{i} ) log ( 1 - p ( {x}_{i} ) ) + {w}_{i} [ log ( p ( {x}_{i} ) ) - λ ( {x}_{i} ) {e}_{i} ]$$

The quantity to be maximized during the M step over the parameters of p and λ (w being fixed) can finally be summarized as:

$${\sum }_{i} {w}_{i} log p ( {x}_{i} ) + ( 1 - {w}_{i} ) log ( 1 - p ( {x}_{i} ) ) + {\sum }_{i} log ( λ ( {x}_{i} ) ) {y}_{i} - λ ( {x}_{i} ) {t}_{i} {w}_{i}$$

$$with {t}_{i} := \{ \begin{matrix}{e}_{i} & if {y}_{i} = 0 \\ {d}_{i} & if {y}_{i} = 1\end{matrix}$$

For joint optimization, a gradient descent algorithm on the regularized negative log likelihood with respect to the parameters of p and A is performed:

$$arg {min}_{{w}_{c} , {w}_{d}} L ( {w}_{c} , {w}_{d} ) + \frac{μ}{2} ( {‖ {w}_{c} ‖}_{2}^{2} + {‖ {w}_{d} ‖}_{2}^{2} )$$

where μ is a regularization parameter and L is the negative log likelihood,

$$L ( {w}_{c} , {w}_{d} ) = - {\sum }_{i , {y}_{i} = 1} log p ( {x}_{i} ) + log λ ( {x}_{i} ) - λ ( {x}_{i} ) {d}_{i} - {\sum }_{i , {y}_{i} = 0} log [ 1 - p ( {x}_{i} ) + p ( {x}_{i} ) exp ( - λ ( {x}_{i} ) {e}_{i} ) ]$$

$$with p ( x ) = \frac{1}{1 + exp ( - {w}_{c} \cdot x )} , λ ( x ) = exp ( {w}_{d} \cdot x ) .$$

This likelihood is the probability of observing Y and D in the case of a conversion to qualified lead and the probability of observing Y otherwise, these probabilities being conditioned on X, E and the model parameters.

Using the chain-rule, the gradients of the negative log likelihood with respect to w_{c} and w_{d} are:

$$\frac{\partial L}{\partial {w}_{c}} = {\sum }_{i , {y}_{i} = 1} - \frac{1}{p ( {x}_{i} )} \frac{\partial p ( {x}_{i} )}{\partial {w}_{c}}$$

$$\frac{\partial L}{\partial {w}_{d}} = {\sum }_{i , {y}_{i} = 1} ( {d}_{i} - \frac{1}{λ ( {x}_{i} )} ) \frac{\partial λ ( {x}_{i} )}{\partial {w}_{d}}$$

Since the optimization problem is unconstrained and twice differentiable, it can be solved with any gradient based optimization technique.

Referring back to FIG. 3, additionally, a qualified lead upload check 322 performs an upload check to allow for the exclusion of training data uploaded by an entity that has not uploaded a piece of interaction data having a label indicating whether a corresponding user is qualified lead within a preset threshold amount of time (for example, 70 days). If the entity has not uploaded such a label with that preset threshold amount of time, the training data filter component 320 can filter out all data corresponding to that entity from the training data.

It should be noted that it is not required that this preset threshold amount of time be fixed. In some example embodiment, it may be dynamically determined using a machine learning model trained to predict a likely time period that a particular entity would take to upload a qualified lead label. This allows the time period to be customized for each entity. In some example embodiments, this machine learning model may be similar to the delayed qualified lead machine learning model 318.

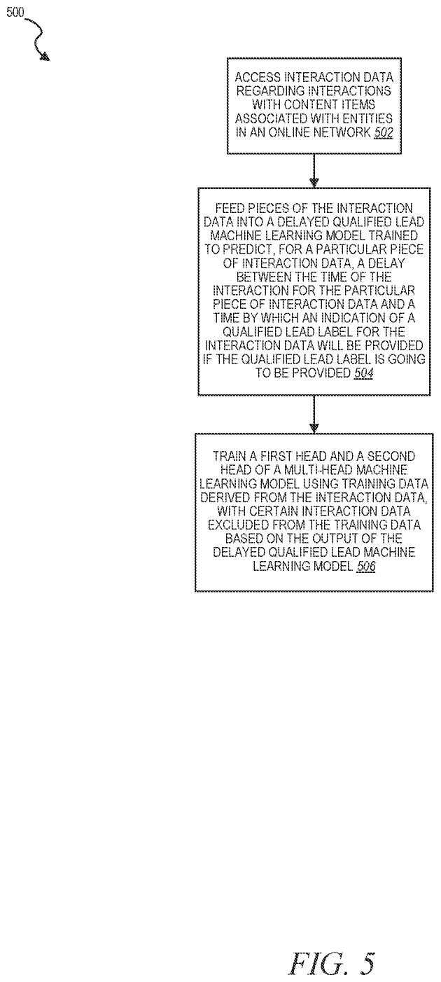

FIG. 5 is a flowchart of an example method 500, in accordance with an example embodiment. At operation 502, interaction data regarding interactions with content items associated with entities in an online network is accessed. The interaction data has been uploaded by the entities and includes times of the interactions. At operation 504, pieces of the interaction data are fed into a delayed qualified lead machine learning model trained to predict, for a particular piece of interaction data, a delay between the time of the interaction for the particular piece of interaction data and a time by which an indication of a qualified lead label for the interaction data will be provided if the qualified lead label is going to be provided. At operation 506, a first head and a second head of a multi-head machine learning model are trained using training data derived from the interaction data, with certain interaction data excluded from the training data based on the output of the delayed qualified lead machine learning model. More specifically, the training of the first head is performed using training data that includes at least some of the interaction data, the first head trained to predict a first likelihood that an input interaction will cause a lead, while the training of the second head performed using training data that includes at least some of the interaction data but that excludes pieces of interaction data indicated as false negatives, including (i) pieces of interaction data in which a time elapsed from a corresponding interaction time is less than a corresponding predicted delay and (ii) pieces of interaction data uploaded by an entity that has been inactive in uploading a qualified lead label within a preset threshold amount of time, the second head trained to predict a second likelihood that the input interaction will cause a qualified lead.

At this point, the multi-head machine learning model may be used to predict whether users are going to be leads and/or qualified leads. This information may be used, for example, in either the use of or the training of one or more downstream machine learning models. Furthermore, in some example embodiments, the multi-head machine learning model may be retrained based on feedback, either feedback from a user or users, or feedback from the downstream machine learning model(s).

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

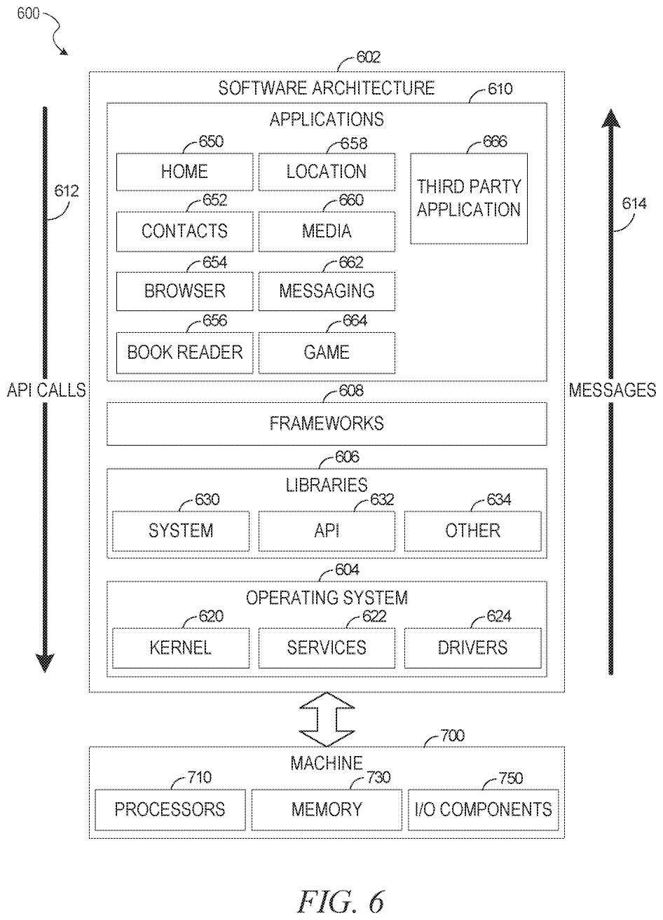

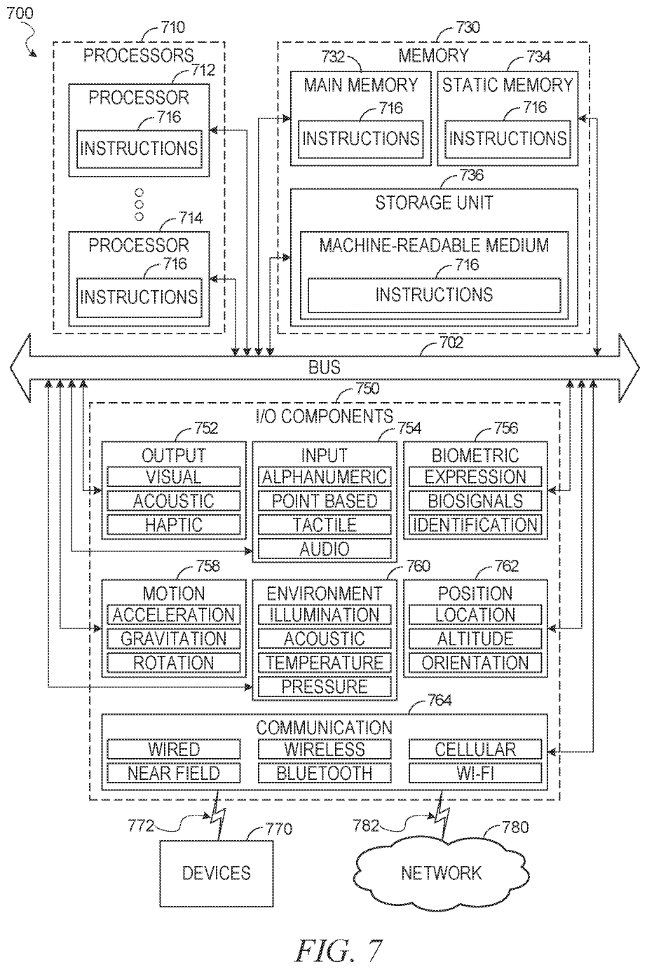

FIG. 6 is a block diagram 600 illustrating a software architecture 602, which can be installed on any one or more of the devices described above. FIG. 6 is merely a non-limiting example of a software architecture, and it will be appreciated that many other architectures can be implemented to facilitate the functionality described herein. In various embodiments, the software architecture 602 is implemented by hardware such as a machine 700 of FIG. 7 that includes processors 710, memory 730, and input/output (I/O) components 750. In this example architecture, the software architecture 602 can be conceptualized as a stack of layers where each layer may provide a particular functionality. For example, the software architecture 602 includes layers such as an operating system 604, libraries 606, frameworks 608, and applications 610. Operationally, the applications 610 invoke API calls 612 through the software stack and receive messages 614 in response to the API calls 612, consistent with some embodiments.

In various implementations, the operating system 604 manages hardware resources and provides common services. The operating system 604 includes, for example, a kernel 620, services 622, and drivers 624. The kernel 620 acts as an abstraction layer between the hardware and the other software layers, consistent with some embodiments. For example, the kernel 620 provides memory management, processor management (e.g., scheduling), component management, networking, and security settings, among other functionalities. The services 622 can provide other common services for the other software layers. The drivers 624 are responsible for controlling or interfacing with the underlying hardware, according to some embodiments. For instance, the drivers 624 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 606 provide a low-level common infrastructure utilized by the applications 610. The libraries 606 can include system libraries 630 (e.g., C standard library) that can provide functions such as memory allocation functions, string manipulation functions, mathematic functions, and the like. In addition, the libraries 606 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 606 can also include a wide variety of other libraries 634 to provide many other APIs to the applications 610.

The frameworks 608 provide a high-level common infrastructure that can be utilized by the applications 610, according to some embodiments. For example, the frameworks 608 provide various graphical user interface functions, high-level resource management, high-level location services, and so forth. The frameworks 608 can provide a broad spectrum of other APIs that can be utilized by the applications 610, some of which may be specific to a particular operating system 604 or platform.

In an example embodiment, the applications 610 include a home application 650, a contacts application 652, a browser application 654, a book reader application 656, a location application 658, a media application 660, a messaging application 662, a game application 664, and a broad assortment of other applications, such as a third-party application 666. According to some embodiments, the applications 610 are programs that execute functions defined in the programs. Various programming languages can be employed to create one or more of the applications 610, structured in a variety of manners, such as object-oriented programming languages (e.g., Objective-C, Java, or C++) or procedural programming languages (e.g., C or assembly language). In a specific example, the third-party application 666 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 666 can invoke the API calls 612 provided by the operating system 604 to facilitate functionality described herein.

FIG. 7 illustrates a diagrammatic representation of a machine 700 in the form of a computer system within which a set of instructions may be executed for causing the machine 700 to perform any one or more of the methodologies discussed herein, according to an example embodiment. Specifically, FIG. 7 shows a diagrammatic representation of the machine 700 in the example form of a computer system, within which instructions 716 (e.g., software, a program, an application 610, an applet, an app, or other executable code) for causing the machine 700 to perform any one or more of the methodologies discussed herein may be executed. For example, the instructions 716 may cause the machine 700 to execute the method 500 of FIG. 5. Additionally, or alternatively, the instructions 716 may implement FIGS. 1-5, and so forth. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other such as via a bus 702. In an example embodiment, the processors 710 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 712 and a processor 714 that may execute the instructions 716. The term “processor” is intended to include multi-core processors 710 that may comprise two or more independent processors 712 (sometimes referred to as “cores”) that may execute instructions 716 contemporaneously. Although FIG. 7 shows multiple processors 710, the machine 700 may include a single processor 712 with a single core, a single processor 712 with multiple cores (e.g., a multi-core processor), multiple processors 710 with a single core, multiple processors 710 with multiple cores, or any combination thereof.

The memory 730 may include a main memory 732, a static memory 734, and a storage unit 736, all accessible to the processors 710 such as via the bus 702. The main memory 732, the static memory 734, and the storage unit 736 store the instructions 716 embodying any one or more of the methodologies or functions described herein. The instructions 716 may also reside, completely or partially, within the main memory 732, within the static memory 734, within the storage unit 736, within at least one of the processors 710 (e.g., within the processor's cache memory), or any suitable combination thereof, during execution thereof by the machine 700

The IO components 750 may include a wide variety of components to receive input, provide output, produce output, transmit information, exchange information, capture measurements, and so on. The specific I/O components 750 that are included in a particular machine 700 will depend on the type of machine 700. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion, and the grouping is in no way limiting. In various example embodiments, the I/O components 750 may include output components 752 and input components 754. The output components 752 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762, among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 762 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772, respectively. For example, the communication components 764 may include a network interface component or another suitable device to interface with the network 780. In further examples, the communication components 764 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a USB).

Moreover, the communication components 764 may detect identifiers or include components operable to detect identifiers. For example, the communication components 764 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 730, 732, 734, and/or memory of the processor(s) 710) and/or the storage unit 736 may store one or more sets of instructions 716 and data structures (e.g., software) embodying or utilized by any one or more of the methodologies or functions described herein. These instructions (e.g., the instructions 716), when executed by the processor(s) 710, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 716 and/or data. The terms shall accordingly be taken to include, but not be limited to, solid-state memories, and optical and magnetic media, including memory internal or external to the processors 710. Specific examples of machine-storage media, computer-storage media, and/or device-storage media include non-volatile memory including, by way of example, semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks, magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 780 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 716 may be transmitted or received over the network 780 using a transmission medium via a network interface device (e.g., a network interface component included in the communication components 764) and utilizing any one of a number of well-known transfer protocols (e.g., HTTP). Similarly, the instructions 716 may be transmitted or received using a transmission medium via the coupling 772 (e.g., a peer-to-peer coupling) to the devices 770. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 716 for execution by the machine 700, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
a non-transitory computer-readable medium having instructions stored thereon, which, when executed by a processor, cause the system to perform operations comprising:
accessing interaction data regarding interactions with content items associated with entities in an online network, wherein the interaction data has been uploaded by the entities, the interaction data including times of the interactions;
feeding pieces of the interaction data into a delayed qualified lead machine learning model trained to predict, for a particular piece of interaction data, a delay between the time of the interaction for the particular piece of interaction data and a time by which an indication of a qualified lead label for the interaction data will be provided; and
training a first head and a second head of a multi-head machine learning model,
the training of the first head performed using training data that includes at least some of the interaction data, the first head trained to predict a first likelihood that an input interaction will cause a lead,
the training of the second head performed using training data that includes at least some of the interaction data but that excludes pieces of interaction data as false negatives, data including (i) pieces of interaction data in which a time elapsed from a corresponding interaction time is less than a corresponding predicted delay and (ii) pieces of interaction data uploaded by an entity that has been inactive in uploading a qualified lead label within a preset threshold amount of time, the second head trained to predict a second likelihood that the input interaction will cause a qualified lead.

2. The system of claim 1, wherein the multi-head machine learning model is a neural network.

3. The system of claim 1, wherein the operations further comprise:
passing the prediction of the first likelihood and the prediction of the second likelihood into another machine learning model trained to determine how much an entity should pay to cause display of a piece of content to a user associated with the first likelihood and the second likelihood.

4. The system of claim 1, wherein the delayed qualified lead machine learning model is a generalized linear model jointly trained with a qualified lead machine learning model trained to output a probability of a qualified lead label being applied to a piece of interaction data.

5. The system of claim 4, wherein the qualified lead machine learning model is a neural network.

6. The system of claim 4, wherein the qualified lead machine learning model and the delayed qualified lead machine learning model are optimized using an expectation-maximization algorithm.

7. The system of claim 4, wherein the qualified lead machine learning model and the delayed qualified lead machine learning model are optimized by optimizing a log likelihood by gradient descent.

8. The system of claim 1, wherein the excluding comprises marking a variable within a loss function of the second head with an indication that a corresponding piece of interaction data was uploaded by an entity that has not uploaded a piece of interaction data having a label indicating whether a corresponding user is qualified lead within a preset threshold amount of time.

9. The system of claim 1, wherein the training of the first head learns from the training of the second head, and vice-versa.

10. The system of claim 1, wherein predictions made using the first head are used in a first stage of a funnel and predictions made using the second head are used in a second stage of the funnel.

11. A method comprising:
accessing interaction data regarding interactions with content items associated with entities in an online network, wherein the interaction data has been uploaded by the entities, the interaction data including times of the interactions;
feeding pieces of the interaction data into a delayed qualified lead machine learning model trained to predict, for a particular piece of interaction data, a delay between the time of the interaction for the particular piece of interaction data and a time by which an indication of a qualified lead label for the interaction data will be provided if the qualified lead label is going to be provided; and
training a first head and a second head of a multi-head machine learning model,
the training of the first head performed using training data that includes at least some of the interaction data, the first head trained to predict a first likelihood that an input interaction will cause a lead,
the training of the second head performed using training data that includes at least some of the interaction data but that excludes pieces of interaction data as false negatives, data including (i) pieces of interaction data in which a time elapsed from a corresponding interaction time is less than a corresponding predicted delay and (ii) pieces of interaction data uploaded by an entity that has been inactive in uploading a qualified lead label within a preset threshold amount of time, the second head trained to predict a second likelihood that the input interaction will cause a qualified lead.

12. The method of claim 11, wherein the multi-head machine learning model is a neural network.

13. The method of claim 11, further comprising:
passing the prediction of the first likelihood and the prediction of the second likelihood into another machine learning model trained to determine how much an entity should pay to cause display of a piece of content to a user associated with the first likelihood and the second likelihood.

14. The method of claim 11, wherein the delayed qualified lead machine learning model is a generalized linear model jointly trained with a qualified lead machine learning model trained to output a probability of a qualified lead label being applied to a piece of interaction data.

15. The method of claim 14, wherein the qualified lead machine learning model is a neural network.

16. The method of claim 14, wherein the qualified lead machine learning model and the delayed qualified lead machine learning model are optimized using an expectation-maximization algorithm.

17. The method of claim 14, wherein the qualified lead machine learning model and the delayed qualified lead machine learning model are optimized by optimizing a log likelihood by gradient descent.

18. The method of claim 11, wherein the excluding comprises marking a variable within a loss function of the second head with an indication that a corresponding piece of interaction data was uploaded by an entity that has not uploaded a piece of interaction data having a label indicating whether a corresponding user is qualified lead within a preset threshold amount of time.

19. The method of claim 11, wherein the training of the first head learns from the training of the second head, and vice-versa.

20. A non-transitory machine-readable storage medium comprising instructions which, when implemented by one or more machines, cause the one or more machines to perform operations comprising:
accessing interaction data regarding interactions with content items associated with entities in an online network, wherein the interaction data has been uploaded by the entities, the interaction data including times of the interactions;
feeding pieces of the interaction data into a delayed qualified lead machine learning model trained to predict, for a particular piece of interaction data, a delay between the time of the interaction for the particular piece of interaction data and a time by which an indication of a qualified lead label for the interaction data will be provided if the qualified lead label is going to be provided; and
training a first head and a second head of a multi-head machine learning model,
the training of the first head performed using training data that includes at least some of the interaction data, the first head trained to predict a first likelihood that an input interaction will cause a lead,
the training of the second head performed using training data that includes at least some of the interaction data but that excludes pieces of interaction data as false negatives, data including (i) pieces of interaction data in which a time elapsed from a corresponding interaction time is less than a corresponding predicted delay and (ii) pieces of interaction data uploaded by an entity that has been inactive in uploading a qualified lead label within a preset threshold amount of time, the second head trained to predict a second likelihood that the input interaction will cause a qualified lead.
